(19) United States
(12) Patent Application Publication
(10) Pub. No.: US 2026/0152015 A1
(43) Pub. Date: Jun. 4, 2026

(54) RECORDING APPARATUS

(71) Applicant: SEIKO EPSON CORPORATION, Tokyo (JP)

(72) Inventors: Yuki MORIYA, SHIOJIRI-SHI (JP); Seiya HAYASHI, MATSUMOTO-SHI (JP); Eiji MIYASHITA, MATSUMOTO-SHI (JP)

(21) Appl. No.: 19/404,668

(22) Filed: Dec. 1, 2025

(30) Foreign Application Priority Data
Dec. 3, 2024 (JP) 2024-209981

(51) Int. Cl. B41J 29/13; B41J 2/17; B41J 25/00; B41J 29/377

(52) U.S. Cl. CPC B41J 29/13; B41J 2/1714; B41J 25/005; B41J 29/377

(57) ABSTRACT

A recording apparatus includes a conveyance unit for a medium, a recording head that performs recording by ejecting ink onto the medium, a carriage on which the recording head is mounted and which reciprocates in a scanning direction, a blower unit that sends air toward the recording head, a detection unit that is located upstream in a conveyance direction of the carriage and between the blower unit and the recording head in a blowing direction of air by the blower unit and detects a position of the carriage in the scanning direction, a housing, and a cover that covers a linear encoder scale of the detection unit so as to block air blow by the blower unit.

The present application is based on, and claims priority from JP Application Serial Number 2024-209981, filed December 3, 2024, the disclosure of which is hereby incorporated by reference herein in its entirety.

### BACKGROUND

### 1. Technical Field

The present disclosure relates to a recording apparatus.

### 2. Related Art

In the past, various recording apparatuses including a conveyance unit that conveys a medium and a carriage on which a recording head that performs recording by ejecting ink is mounted and which reciprocates in a scanning direction have been used. Among these, some of the recording apparatuses include a linear encoder scale and a linear encoder sensor for detecting a position of the carriage. For example, JP-A-2013-237172 discloses an image forming apparatus that includes a conveyance roller that conveys a medium, a carriage on which a recording head is mounted and which reciprocates in a scanning direction, a linear encoder scale, and a linear encoder sensor, and further includes an air flow path through which air can flow from a communication port to a ventilation port, and a fan that forms an air flow.

JP-A-2013-237172 is an example of the related art.

In such a related-art recording apparatus including the linear encoder scale as disclosed in JP-A-2013-237172, when the linear encoder scale is contaminated with ink mist, it is difficult to accurately detect the position of the carriage. When the position of the carriage cannot be accurately detected, there is a concern that the quality of an image formed on the medium may deteriorate. Therefore, the image forming apparatus in JP-A-2013-237172 is provided with a configuration including the air flow path and the fan to thereby attempt to suppress the adhesion of the mist to the linear encoder scale, but in a configuration in which the conveyance unit is disposed over the entire width direction (scanning direction) and so on, it is difficult to form the communication port at a desired position. Therefore, in particular in a large-sized apparatus or the like, it is difficult to suppress the adhesion of the mist to the linear encoder scale. In addition, it is conceivable to adopt a configuration in which the recording head and the linear encoder scale are disposed in respective rooms separated from each other to be isolated from each other, but such a configuration increases the size and complexity of the apparatus and cannot therefore be adopted in many cases.

### SUMMARY

A recording apparatus according to the present disclosure for solving the problem described above includes a conveyance unit configured to convey a medium in a conveyance direction, a recording head configured to record an image by ejecting ink onto the medium conveyed by the conveyance unit, a carriage on which the recording head is mounted and which is configured to reciprocate in a scanning direction crossing the conveyance direction, a blower unit configured to send air toward the recording head, a linear encoder scale and a linear encoder sensor which are located upstream in the conveyance direction of the carriage and between the blower unit and the recording head in a blowing direction of air by the blower unit, and which are configured to detect a position of the carriage in the scanning direction, a housing configured to house the carriage, the linear encoder scale, and the linear encoder sensor, and a cover configured to cover the linear encoder scale so as to block air blow by the blower unit.

### BRIEF DESCRIPTION OF THE DRAWINGS

FIG. 1 is a schematic side view illustrating a recording apparatus according to Example 1 of the present disclosure.

FIG. 2 is a side cross-sectional view showing an internal configuration of the recording apparatus of FIG. 1, and is a diagram illustrating a flow of air.

FIG. 3 is a perspective view corresponding to the region S in FIG. 2, and is a diagram showing a periphery of a cover.

FIG. 4 is a perspective view illustrating a periphery of a cover in an internal configuration of a recording apparatus according to Example 2 of the present disclosure.

### DESCRIPTION OF EMBODIMENTS

First, the present disclosure will schematically be described.

A recording apparatus according to a first aspect of the present disclosure for solving the problem described above includes a conveyance unit configured to convey a medium in a conveyance direction, a recording head configured to record an image by ejecting ink onto the medium conveyed by the conveyance unit, a carriage on which the recording head is mounted and which is configured to reciprocate in a scanning direction crossing the conveyance direction, a blower unit configured to send air toward the recording head, a linear encoder scale and a linear encoder sensor which are located upstream in the conveyance direction of the carriage and between the blower unit and the recording head in a blowing direction of air by the blower unit, and which are configured to detect a position of the carriage in the scanning direction, a housing configured to house the carriage, the linear encoder scale, and the linear encoder sensor, and a cover configured to cover the linear encoder scale so as to block air blow by the blower unit.

According to the present aspect, the cover that covers the linear encoder scale so as to block the air blow by the blower unit is provided. Such a configuration can be applied regardless of the configuration, size, and so on of the apparatus, and the attachment of the mist to the linear encoder scale can be suppressed by adopting such a configuration.

A recording apparatus according to a second aspect of the present disclosure is the recording apparatus according to the first aspect described above, wherein the cover covers the linear encoder scale in a direction along the conveyance direction.

According to the present aspect, the cover covers the linear encoder scale in the direction along the conveyance direction. The blower unit sends air toward the recording head, and the linear encoder scale is located between the blower unit and the recording head in the blowing direction, and is disposed upstream in the conveyance direction of the carriage. In such a configuration, the mist can flow along the conveyance direction. However, by adopting a configuration in which the cover covers the linear encoder scale in the direction along the conveyance direction, the cover can protect the linear encoder scale from the mist that can flow in the conveyance direction.

A recording apparatus according to a third aspect of the present disclosure is the recording apparatus according to one of the first and second aspects described above, wherein the cover does not cover the linear encoder scale when viewed in an opposite direction to the blowing direction.

According to the present aspect, the cover does not cover the linear encoder scale when viewed in the opposite direction to the blowing direction. By adopting such a configuration, a wide work space can be provided downstream in the blowing direction, and it is possible to easily access the linear encoder scale from downstream in the direction in which the mist can flow to thereby easily perform replacement and so on of the linear encoder scale.

A recording apparatus according to a fourth aspect of the present disclosure is the recording apparatus according to one of the first and second aspects described above, wherein the cover has a U shape having an upward opening when viewed in the scanning direction.

According to the present aspect, the cover has the U shape having the upward opening when viewed in the scanning direction. By adopting such a configuration, it is possible to provide the cover with the roles of a storage unit for storing the mist and a gutter portion that allows the mist to flow. Note that the U shape having the upward opening is not limited to a shape with a lower portion rounded, but means to include, for example, a V shape and a shape obtained by rotating the square bracket by a quarter revolution in which the lower portion is formed of planes.

A recording apparatus according to a fifth aspect of the present disclosure is the recording apparatus according to any one of the first to fourth aspects described above, further including a discharge port which is disposed downstream in the conveyance direction of the carriage in the housing, and through which the air sent by the blower unit is discharged outside the housing.

According to the present aspect, there is provided the discharge port which is disposed downstream in the conveyance direction of the carriage in the housing, and through which the air sent by the blower unit is discharged outside the housing. By adopting such a configuration, the mist discharged from the discharge port can efficiently be collected.

### Example 1

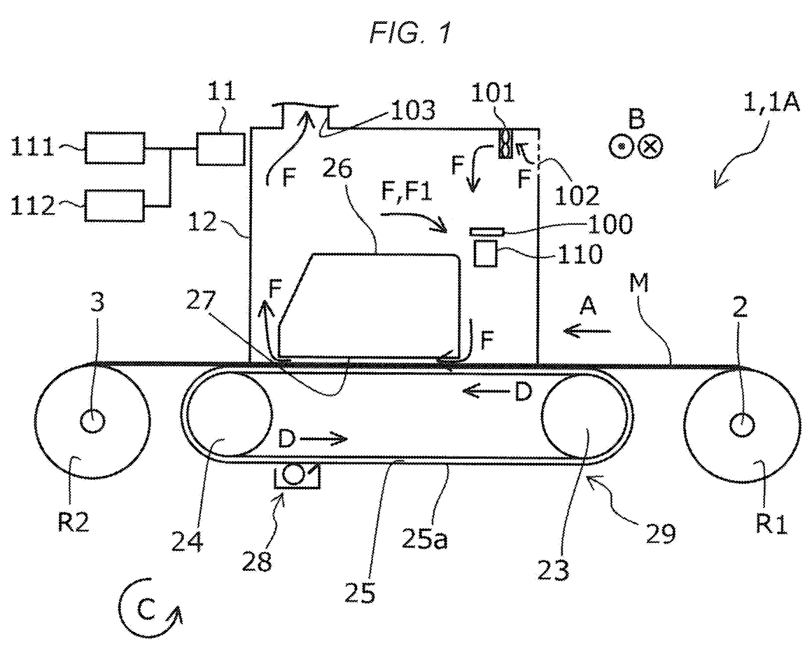

An embodiment according to the present disclosure will hereinafter be described with reference to the accompanying drawings. First, an outline of a recording apparatus 1A according to Example 1 as an example of a recording apparatus 1 according to the present disclosure will be described with reference to FIG. 1. As illustrated in FIG. 1, the recording apparatus 1A according to the present example includes a holding unit 2 that can rotatably hold a roll body R1 obtained by rolling a medium M such as a fabric into a roll. In addition, a conveyance unit 29 that conveys the medium M and a recording head 27 that records an image by ejecting ink onto the medium M conveyed by the conveyance unit 29 are provided. Further, a take-up unit 3 that can form a roll body R2 by rolling the medium M on which recording has been performed into a roll is provided.

The holding unit 2 holds a paper pipe forming a rotary shaft of the roll body R1, and can rotate in a rotational direction C to feed the medium M from the roll body R1 to the conveyance unit 29 of the recording apparatus 1A. Note that the holding unit 2 may be configured separately from the recording apparatus 1A but may be a part of component members of the recording apparatus 1A.

The recording apparatus 1A according to the present example is an inkjet printer that can form an image on the medium M by ejecting ink as a liquid in the form of droplets. The recording apparatus 1A includes, as the conveyance unit 29, a driven roller 23 located upstream in a conveyance direction A, which is a conveyance direction of the medium M, a driving roller 24 located downstream in the conveyance direction A, and a conveyance belt 25, which is an endless belt stretched between the driven roller 23 and the driving roller 24. Here, the conveyance belt 25 is an adhesive belt having an outer circumferential surface 25a on which a pressure-sensitive adhesive is applied in a support surface for the medium M, which is an outside surface.

As illustrated in FIG. 1, in the conveyance unit 29, the medium M is supported and conveyed by the conveyance belt 25 in a state where the medium M is attached to the outer circumferential surface 25a. In the recording apparatus 1A according to the present example, a medium support region for supporting the medium M in the conveyance belt 25 is an upper region stretched between the driven roller 23 and the driving roller 24. Further, the driving roller 24 is a roller that rotates in the rotational direction C by driving force of a motor (not illustrated), and the driven roller 23 is a roller that is rotated in accordance with the rotation of the conveyance belt 25 due to the rotation of the driving roller 24.

That is, a moving direction of the conveyance belt 25 when conveying the medium M is a moving direction D corresponding to the rotational direction C, and a moving direction of the conveyance belt 25 in the medium support region is the conveyance direction A. However, except the conveyance period of the medium M, the driving roller 24 can be rotated in an opposite direction to the rotational direction C to thereby move the conveyance belt 25 in an opposite direction to the moving direction D.

Further, the recording apparatus 1A according to the present example includes a carriage 26 that can reciprocate in a width direction B of the conveyance belt 25, and the recording head 27 attached to the carriage 26. The recording head 27 is a recording unit that can form an image on the medium M conveyed in the conveyance direction A by ejecting the ink as a liquid onto the medium M based on recording data. In addition, the recording apparatus 1A of the present example includes a cleaning unit 28 that cleans the conveyance belt 25 downstream in the moving direction D of the conveyance belt 25 of the recording head 27.

Further, the recording apparatus 1A of the present example can form an image by ejecting the ink from the recording head 27 onto the medium M thus conveyed while reciprocating the carriage 26 in the width direction B crossing the conveyance direction A. Since the carriage 26 having such a configuration is provided, the recording apparatus 1A of the present example can form a desired image on the medium M by repeating conveying the medium M in the conveyance direction A by a predetermined conveyance amount and ejecting the ink while moving the carriage 26 in the width direction B in a state where the medium M is at rest.

Further, as described above, the recording apparatus 1A of the present example includes the take-up unit 3. The medium M on which an image is formed by ejecting the ink from the recording head 27 is wound up as the roll body R2 by the take-up unit 3. The take-up unit 3 can form the roll body R2 by holding the paper pipe as the rotary shaft for forming the roll body R2, and rotating in the rotational direction C to wind up the medium M around the paper pipe. Note that the take-up unit 3 may be configured separately from the recording apparatus 1A but may be a part of the component members of the recording apparatus 1A. Further, a drying device for drying the ink ejected onto the medium M or the like may be disposed between the take-up unit 3 and the recording apparatus 1A.

Here, as the medium M, a textile printing target material can be preferably used. The textile printing target material refers to a fabric, clothes, other clothing products, and the like to be a target of textile printing. Examples of the fabric include woven fabrics, knitted fabrics, and nonwoven fabrics of natural fibers such as cotton, silk, and wool, chemical fibers such as nylon, or composite fibers as mixtures of these fibers. Further, the clothes and other clothing products include sewn T-shirts, handkerchiefs, scarves, towels, handbags, cloth bags, and furniture fabric products such as curtains, bed sheets, and bed covers, as well as fabrics before and after cutting and present as parts to be sewed. However, in addition to the textile printing target material, plain paper, high-quality paper, and special paper exclusive to inkjet recording such as glossy paper can also be used.

As described above, the recording apparatus 1A of the present example includes the conveyance unit 29 that conveys the medium M in the conveyance direction A, the recording head 27 that records an image by ejecting the ink onto the medium M conveyed by the conveyance unit 29, and the carriage 26 on which the recording head 27 is mounted and which reciprocates in the scanning direction corresponding to the width direction B crossing the conveyance direction A. In addition, as illustrated in FIG. 1, the recording apparatus 1A of the present example includes a blower unit 101 that sends air toward the recording head 27. Further, the recording apparatus 1A includes a detection unit 110 located upstream in the conveyance direction A of the carriage 26 and between the blower unit 101 and the recording head 27 in a blowing direction F of the air by the blower unit 101, and including a linear encoder scale 111 and a linear encoder sensor 112 for detecting the position of the carriage 26 in the scanning direction (width direction B) of the carriage 26.

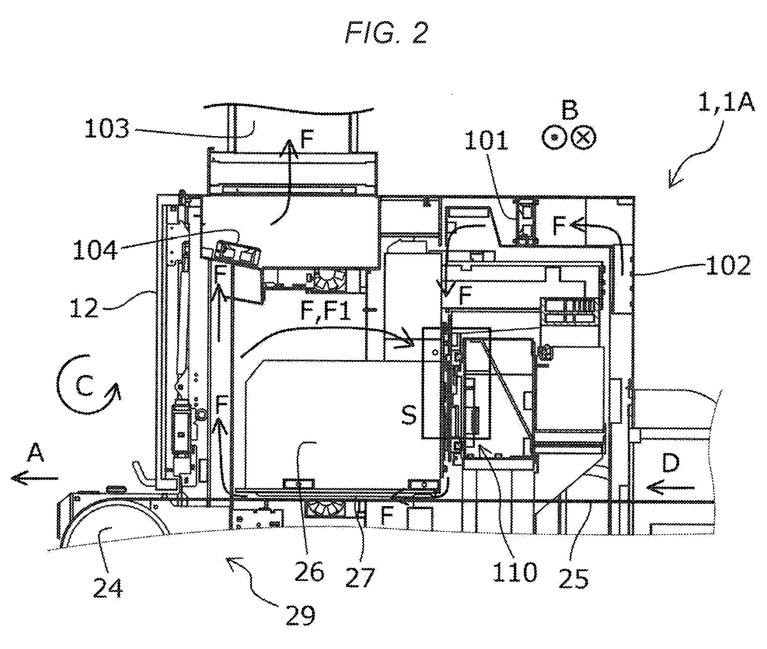

Note that as illustrated in FIGS. 1 and 2, the blowing direction F is a downward direction upstream in the conveyance direction A of the carriage 26, is the same direction as the conveyance direction A in the scanning region of the carriage 26 in the conveyance direction A, and is an upward direction downstream in the conveyance direction A of the carriage 26. Therefore, the blowing direction F in the region where the detection unit 110 including the linear encoder scale 111 and the linear encoder sensor 112 is located is the downward direction.

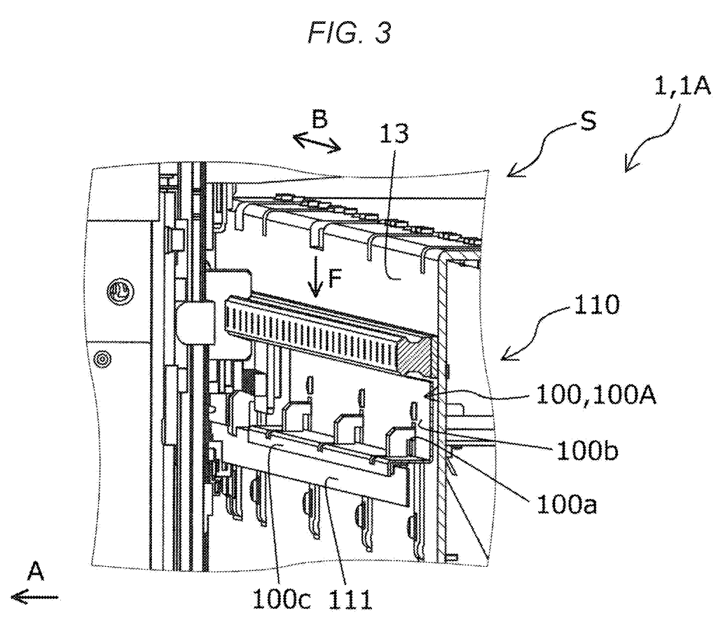

In addition, as illustrated in FIG. 1, the recording apparatus 1A of the present example includes a housing 12 in which the carriage 26 and the detection unit 110 including the linear encoder scale 111 and the linear encoder sensor 112 are housed. In addition, the recording apparatus 1A according to the present example includes an opening 102 which is disposed upstream in the conveyance direction A of the carriage 26 in the housing 12 and can take air into the apparatus. Here, the recording apparatus 1A of the present example further includes a cover 100 at a position where the cover 100 blocks the air blow by the blower unit 101. Therefore, the details of a cover 100A of the present example as the cover 100 will hereinafter be described with reference to FIGS. 2 and 3.

As illustrated in FIG. 3 illustrating the region S in FIG. 2, the cover 100A of the recording apparatus 1A of the present example is configured to cover the linear encoder scale 111 so as to block the air blow by the blower unit 101. Such a configuration can be applied regardless of the configuration, size, and so on of the apparatus, and the attachment of the mist to the linear encoder scale 111 can be suppressed by adopting such a configuration.

In particular, in the recording apparatus 1A of the present example, regarding the blowing direction F, most of the air blow by the blower unit 101 flows from the blower unit 101 toward a discharge port 103, but a circulation air flow circulating inside the apparatus is also generated as represented by the blowing direction F1. The circulation air flow includes the mist, but by adopting such a configuration, it is possible to effectively suppress adhesion of the mist of the circulation air flow to the linear encoder scale 111. In addition, as illustrated in FIG. 2, in the recording apparatus 1A of the present example, a fan 104 is disposed at an inlet portion of the discharge port 103 in order to reduce the circulation air flow circulating inside the apparatus.

Note that in the recording apparatus 1A of the present example, after recording is completed, the air blow by the blower unit 101 is stopped from the viewpoint of a reduction of power consumption. Therefore, after the recording is completed, the air blow by the blower unit 101 is stopped, and the mist in the apparatus falls downward by gravity. The mist of the circulation air flow also exists above the linear encoder scale 111 on that occasion, but the recording apparatus 1A of the present example includes the cover 100A, and thus it is possible to suppress the mist from adhering to the linear encoder scale 111 on that occasion. Further, by providing the cover 100A having such a configuration, it is also possible to suppress that a strong airflow hits the linear encoder scale 111 to vibrate the linear encoder scale 111 during the recording operation.

Here, as illustrated in FIG. 3, the cover 100A of the present example includes a lower surface portion 100a that extends over the entire width direction B to block the air blow by the blower unit 101, a wall portion 100b that is coupled to a sheet metal portion 13 and extends upward over the entire width direction B upstream in the conveyance direction A of the lower surface portion 100a, and a wall portion 100c that extends downward over the entire width direction B downstream in the conveyance direction A of the lower surface portion 100a. In another expression, the cover 100A of the present example covers, with the sheet metal portion 13 and the wall portion 100c, the linear encoder scale 111 in a direction along the conveyance direction A, in other words, in a direction crossing the blowing direction F in the region where the linear encoder scale 111 is disposed.

As described above, in the recording apparatus 1A of the present example, the blower unit 101 sends air toward the recording head 27, and the linear encoder scale 111 is located between the blower unit 101 and the recording head 27 in the blowing direction F, and is disposed upstream in the conveyance direction A of the carriage 26. In such a configuration, in the recording apparatus 1A of the present example, the mist can flow in a direction along the conveyance direction A in the vicinity of the carriage 26 or the like.

However, in the recording apparatus 1A of the present example, when regarding the sheet metal portion 13 as a part of the cover 100A, since there is adopted a configuration including such a sheet metal portion 13 and the wall portion 100c, it can be expressed that the linear encoder scale 111 can be protected from the mist which can flow in a direction along the conveyance direction A with the sheet metal portion 13 and the wall portion 100c. In addition, in the recording apparatus 1A of the present example, the wall portion 100c covers only a part of an area above the linear encoder scale 111 in the direction along the conveyance direction A, but may cover the whole of the linear encoder scale 111 in the direction along the conveyance direction A by adopting a structure further extending downward.

Meanwhile, as illustrated in FIG. 3, the cover 100A of the present example is not provided with a wall portion below the linear encoder scale 111, in other words, downstream in the blowing direction F of the linear encoder scale 111. In another expression, the cover 100A of the present example does not cover the linear encoder scale 111 when viewed in an opposite direction to the blowing direction F in the region where the linear encoder scale 111 is disposed. In the recording apparatus 1A of the present example, since such a configuration is adopted, a wide work space can be provided downstream in the blowing direction F of the lower surface portion 100a, and the operator can easily access the linear encoder scale 111 from downstream in the direction in which the mist can flow to thereby easily perform replacement and so on of the linear encoder scale 111.

In addition, the recording apparatus 1A of the present example includes the discharge port 103 which is disposed downstream in the conveyance direction A of the carriage 26 in the housing 12, and through which the air sent by the blower unit 101 is discharged outside the housing 12. Since the recording apparatus 1A of the present example adopts such a configuration, the recording apparatus 1A can efficiently collect the mist discharged from the discharge port 103. Note that downstream in the conveyance direction A of the carriage 26 means that it is sufficient to include a region downstream of the carriage 26.

### Example 2

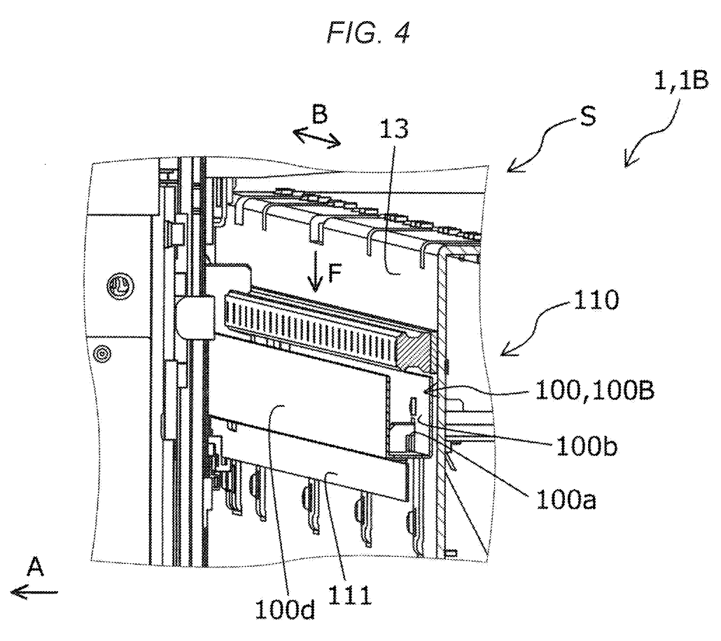

Then, a recording apparatus 1B of Example 2 will be described using FIG. 4. Note that FIG. 4 is a diagram corresponding to FIG. 3 in the recording apparatus 1A of Example 1. In FIG. 4, component members common to Example 1 described above are denoted by the same reference numerals and the detailed description thereof will be omitted. Here, the recording apparatus 1B of the present example has substantially the same configuration as that of the recording apparatus 1A of Example 1 except the configuration of the cover 100 described below. Accordingly, the recording apparatus 1 of the present example has substantially the same characteristics as those of the recording apparatus 1A of Example 1 regarding other portions than a portion described below.

As illustrated in FIG. 4, the recording apparatus 1B of the present example includes, as the cover 100, a cover 100B different in shape from the cover 100A of the recording apparatus 1A of Example 1. Specifically, the cover 100B of the present example is provided with a wall portion 100d downstream in the conveyance direction A of the lower surface portion 100a, and has a U shape having an upward opening when viewed in the width direction B corresponding to the scanning direction of the carriage 26.

Since the recording apparatus 1B of the present example has such a configuration, the recording apparatus 1B provides the cover 100B with roles of a storage unit for storing the mist, a gutter portion that allows the mist thus stored to flow in one predetermined direction, and so on. Further, a replaceable absorber (not shown) is disposed at a flow destination of the mist thus stored so that the mist can be absorbed by the absorber.

Note that the cover 100B of the present example has a shape obtained by rotating a square bracket by a quarter revolution to have an upward opening. As described above, the U shape having the upward opening is not limited to a shape with a lower portion rounded, but means to include, for example, a V shape in addition to the shape obtained by rotating the square bracket by a quarter revolution as in the cover 100B of the present example in which the lower portion thereof is formed of planes.

Note that the present disclosure is not limited to the examples described above, and various modifications can be made within the scope of the disclosure set forth in the appended claims, and such modifications are obviously included within the scope of the present disclosure.

What is claimed is:

1. A recording apparatus comprising:
a conveyance unit configured to convey a medium in a conveyance direction;
a recording head configured to record an image by ejecting ink onto the medium conveyed by the conveyance unit;
a carriage on which the recording head is mounted and which is configured to reciprocate in a scanning direction crossing the conveyance direction;
a blower unit configured to send air toward the recording head;
a linear encoder scale and a linear encoder sensor which are located upstream in the conveyance direction of the carriage and between the blower unit and the recording head in a blowing direction of air by the blower unit, and which are configured to detect a position of the carriage in the scanning direction;
a housing configured to house the carriage, the linear encoder scale, and the linear encoder sensor; and
a cover configured to cover the linear encoder scale so as to block air blow by the blower unit.

2. The recording apparatus according to claim 1, wherein
the cover covers the linear encoder scale in a direction along the conveyance direction.

3. The recording apparatus according to claim 1, wherein
the cover does not cover the linear encoder scale when viewed in an opposite direction to the blowing direction.

4. The recording apparatus according to claim 1, wherein
the cover has a U shape having an upward opening when viewed in the scanning direction.

5. The recording apparatus according to claim 1, further comprising
a discharge port which is disposed downstream in the conveyance direction of the carriage in the housing, and through which the air sent by the blower unit is discharged outside the housing.
